(19) United States
(12) Patent Application Publication
(10) Pub. No.: US 2010/0000779 A1
(43) Pub. Date: Jan. 7, 2010

(54) BONDED STRUCTURE AND METHOD OF PRODUCING THE SAME

(75) Inventors: Akiyoshi HATTORI, Nagoya-City (JP); Hirokazu NAKANISHI, Nagoya-City (JP)

Correspondence Address: BURR & BROWN, PO BOX 7068, SYRACUSE, NY, 13261-7068, US

(73) Assignee: NGK Insulators, Ltd., Nagoya-City (JP)

(21) Appl. No.: 12/478,876

(22) Filed: Jun. 5, 2009

(30) Foreign Application Priority Data
Jul. 1, 2008 (JP) 2008-172746

(51) Int. Cl. H01R 12/04; B32B 37/00

(52) U.S. Cl. 174/267; 156/212

(57) ABSTRACT

The invention provides a bonded body including: a ceramic base that is mainly composed of alumina, includes a printed electrode embedded therein and composed of a high-melting-point conductive carbide and alumina, and has a concavity concaved at one surface concaved toward the printed electrode, and a terminal hole extending from the bottom of the concavity to the printed electrode; a terminal that is made of a sintered body of niobium carbide (NbC) /alumina (Al₂O₃) mixture and is placed in the terminal hole and has a first surface in contact with the printed electrode and a second surface exposed at the bottom of the concavity; a braze layer that is provided in the concavity to be in contact with the second surface of the terminal; and a connecting member made of a high-melting-point metal having a coefficient of thermal expansion close to that of the ceramic base.

### BACKGROUND OF THE INVENTION

1. Field of the Invention

The present invention relates to a bonded structure and a method of producing the same. More specifically, the present invention relates to a bonded structure in which a connecting member is bonded to a terminal embedded in a ceramic base, that is, a bonded structure including a connecting member that supplies electric power to an electrode embedded in a ceramic base, and a method of producing such a bonded structure.

2. Description of the Related Art

Generally, semiconductor manufacturing equipment such as an etching device and a CVD device employs a susceptor such as an electrostatic chuck in which an electrode is embedded in a ceramic base. Examples of such susceptors for semiconductors include a susceptor having a base composed of aluminum nitride or dense alumina and an electrode embedded in the base and working as a discharge electrode for generating plasma, and a susceptor having a base composed of aluminum nitride or dense alumina and a metal resistor Ca heater) embedded in the base and working as a ceramic heater for controlling temperature of a wafer in heat treatment process such as CVD process. Japanese Patent Laid-open Publication No. 2006-196864 discloses a susceptor having an electrode embedded in a base and working as an electrostatic chuck for electrostatically attracting and holding a semiconductor wafer in processes of carrying the wafer, exposing, forming films by CVD and sputtering, microfabrication, washing, etching, and dicing.

As the embedded electrode, a metal bulk body electrode having a mesh structure as well as a printed electrode formed by printing a conductive paste is used. Particularly, printed electrodes are used in many cases in view of facilitating manufacturing process and enhancing flatness. The printed electrode is electrically connected to the outside via a terminal embedded along with the electrode. Specifically, in many cases, such terminal is bonded to a connecting member by brazing, and the connecting member is connected to the external electricity supply device.

### SUMMARY OF THE INVENTION

In the susceptors described above, electric disconnection sometimes occurs at the phase boundary between the terminal and the printed electrode, and a fragile layer tends to be formed at the phase boundary between the terminal and the braze layer. Therefore, in the susceptor for semiconductor, there has been a demand for a long-term high bonding strength and reliability in electric connection.

An object of the present invention is to provide a bonded structure having a reliable bonding strength of a terminal with an electrode and a braze layer, where disconnection does not occur at the phase boundary between the terminal and the electrode, and a fragile layer does not form at the boundary of the terminal and the braze layer, as well as to provide a producing method of such a bonded structure.

The present invention according to one aspect is directed to a bonded structure, including: a ceramic base that is mainly composed of alumina, includes a printed electrode embedded therein and composed of a high-melting-point conductive carbide and alumina, and has a concavity and a terminal hole, the concavity being concaved at a surface of the ceramic base toward the printed electrode and the terminal hole extending from a bottom of the concavity to the printed electrode; a terminal that is made of a sintered body of a mixture of niobium carbide (NbC) and alumina (Al₂O₃) and is placed in the terminal hole so that a first surface of the terminal is in contact with the printed electrode and a second surface of the terminal is exposed at the bottom of the concavity; a braze layer that is provided in the concavity to be in contact with the second surface of the terminal; and a connecting member that is made of a high-melting-point metal having a coefficient of thermal expansion close to that of the ceramic base and is inserted into the concavity to be in contact with the braze layer.

The present invention according to another aspect is directed to a method of producing a bonded structure, including: forming a printed electrode composed of a high-melting-point conductive carbide and alumina on a surface of a first ceramic base composed mainly of alumina; placing a terminal made of a sintered body of a mixture of niobium carbide (NbC) and alumina (Al₂O₃) SO that a first surface of the terminal is in contact with the printed electrode; providing alumina powder to cover the terminal and the printed electrode and firing the alumina powder to form a second ceramic base, so as to obtain an integral ceramic base in which the printed electrode and the terminal are embedded between the first ceramic base and the second ceramic base; forming a concavity that is concaved at a surface of the integral ceramic base toward the printed electrode to expose a second surface of the terminal at a bottom of the concavity; providing a braze layer in the concavity to be in contact with the second surface of the terminal; and inserting a connecting member made of a high-melting-point metal having a coefficient of thermal expansion close to that of the integral ceramic base into the concavity to be in contact with the braze layer.

The present invention provides a bonded structure having a reliable bonding strength of a terminal with an electrode and a braze layer, where disconnection does not occur at the phase boundary between the terminal and the electrode and a fragile layer does not form at the boundary of the terminal and the braze layer. The present invention also provides a method of producing such a bonded structure.

### BRIEF DESCRIPTION OF THE DRAWINGS

FIG. 1 shows schematic cross-sectional views of a susceptor according to an embodiment of the present invention, where FIG. 1A is a longitudinal cross-sectional view, FIG. 1B is a cross-sectional view, taken along a line A1-A2 of FIG. 1A parallel to a surface of a ceramic base included in the susceptor, and FIG. 1C is a cross-sectional view, taken along a line B1-B2 of FIG. 1A parallel to the surface of the ceramic base included in the susceptor;

FIG. 2 is schematic view showing a producing process of the susceptor;

FIG. 3 is schematic view showing a producing process of the susceptor;

FIG. 4 is schematic view showing a producing process of the susceptor;

FIG. 5 is schematic view showing a producing process of the susceptor;

FIG. 6 is schematic view showing a producing process of the susceptor;

FIG. 7 is schematic view showing a producing process of the susceptor;

FIG. 8 is schematic view showing a producing process of the susceptor;

FIG. 9 shows photographs of cross-sectional views of the susceptor, where FIG. 9A is a longitudinal cross-sectional view, and FIG. 9B is an enlarged view of an area defined by a square in FIG. 9A; and

FIG. 10 shows photographs of cross-sectional views of the susceptor, where FIG. 10A is a longitudinal cross-sectional view, and FIG. 10B is an enlarged view of an area defined by a square in FIG. 1A.

### DESCRIPTION OF THE PREFERRED EMBODIMENTS

Some modes of carrying out the invention are described below as preferred embodiments, however, the invention is not limited to the embodiments. Elements having the same or analogous function are assigned with an identical or analogous number, and duplicate explanation is omitted.

Susceptor for Semiconductor (Bonded Structure)

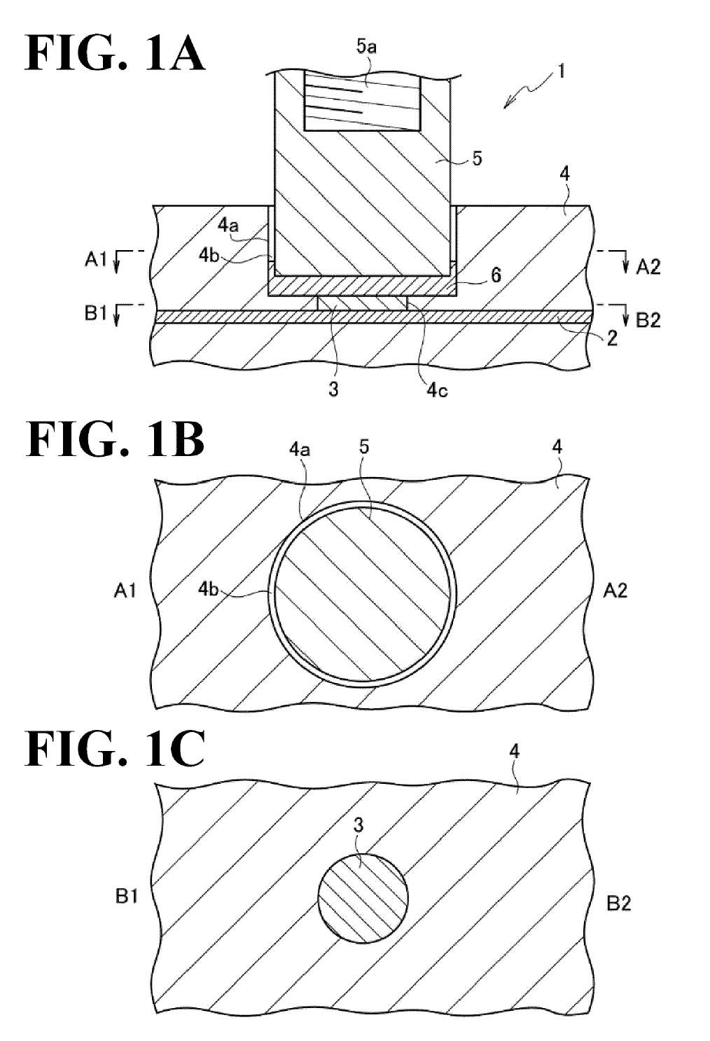

FIG. 1A is a longitudinal cross-sectional view of a susceptor (bonded structure) 1 according to an embodiment, FIG. 1B is a cross-sectional view, taken along a line A1-A2 of FIG. 1A parallel to a surface of a ceramic base included in the susceptor, and FIG. 1C is a cross-sectional view, taken along a line B1-B2 of FIG. 1A parallel to the surface of the ceramic base included in the susceptor. Description of the susceptor 1 of the embodiment can be also interpreted as description of a bonded structure, as well as description of a semiconductor manufacturing apparatus including such a bonded structure.

The susceptor 1 according to the embodiment includes: a ceramic base 4 that is mainly composed of alumina, includes a printed electrode 2 embedded therein and composed of a high-melting-point conductive carbide and alumina, and has a concavity 4a concaved at one surface concaved toward the printed electrode 2, and a terminal hole 4c extending from the bottom of the concavity 4a to the printed electrode 2. The susceptor 1 further includes: a terminal 3 that is made of a sintered body of niobium carbide (NbC)/alumina (Al₂O₃) mixture and is placed in the terminal hole 4c and has a first surface in contact with the printed electrode 2 and a second surface exposed at the bottom of the concavity 4a; a braze layer 6 that is provided in the concavity 4a to be in contact with the second surface of the terminal 3; and a connecting member 5 made of a high-melting-point metal having a coefficient of thermal expansion close to that of the ceramic base 4.

The printed electrode 2 is preferably a printed electrode formed by printing a paste made of alumina powder-tungsten carbide (WC) powder mixture. The inner diameter of the concavity 4a is larger than the external diameter of the connecting member 5. Clearance 4b is provided between wall of the concavity 4a and the connecting member 5 to allow insertion of the connecting member 5 into the concavity 4a and thermal expansion of the inserted connecting member 5. The clearance 4b may be provided to surround the inserted connecting member 5, or otherwise a part of the connecting member 5 may be in contact with the wall of the concavity 4a.

The braze layer 6 is provided in a space between an end face of the connecting member 5 and the second surface (exposed surface) of the terminal 3, as shown in FIG. 1A and FIG. 7.

The connecting member 5 has a spiral groove 5a. Though not illustrated for the reason of convenience, an end of an electrode for supplying electric power to the susceptor 1 is screwed into the groove 5a.

The clearance 4b is preferably more than 0 mm and not more than 0.5 mm, when the external diameter of the connecting portion is 4 to 6 mm. When the clearance 4b is less than the lower limit, the connecting member 5 cannot be inserted into the concavity 4a. On the other hand, when the clearance 4b is more than the upper limit and the inner diameter of the concavity 4a is large, impurities tend to get in the concavity 4a and may cause contamination and corrosion of the electrode. In view that a larger concavity 4a lowers the strength of the ceramic base 4 and that the wall of the concavity 4a can function as a guide for inserting the connecting member 5, the concavity 4a need not to be larger than is required.

The ceramic base 4 is preferably composed mainly of alumina (Al₂O₃). The purity of the alumina is preferably not less than 99%, more preferably not less than 99.5%, to achieve high electrical resistivity of the ceramic base 4. With the purity of alumina within this range, an electrostatic shuck to be obtained can exert a desirable Coulomb force. For an electrostatic chuck using the Johnsen-Rahbek effect, on the other hand, alumina to which a transition metal element, such as titanium, is added as a doping agent may also be preferably used.

The terminal 3 is made of a sintered body of a mixture of alumina (Al₂O₃) and niobium carbide (NbC). The terminal 3 made of these components neither reacts with the braze layer 6 nor forms a fragile compound that causes lowering of the strength of the bonded structure. It is preferable that the terminal 3 is composed only of alumina and niobium carbide, and contains 5 to 60 wt % of alumina with respect to the total weight of the terminal 3. With this composition ratio, the terminal 3 can have a coefficient of thermal expansion close to that of alumina, and the diameter of the terminal 3 can be made larger to allow higher flow of electric current. It is advantageous that the terminal 3 with this composition ratio does not evolve heat even when a large current flows, compared with a terminal mainly composed of tungsten carbide (WC).

The terminal 3 is preferably in a tablet shape having a diameter of not more than 3 mm. The terminal 3 in this shape can be produced relatively easily, and protected from being damaged by, for example, heat cycle while keeping a reliable electric interengagement with the connecting member 5. Here, the preferable range of the diameter of the terminal 3 is mentioned in view of clearly specifying the maximum diameter of the terminal 3 allowing a flow of a large current. The minimum value of the diameter is not limited as far as the terminal 3 can be electrically interengaged with the printed electrode 2 and the connecting member 5, and may be, for example, about 2 mm or 1 mm.

The terminal 3 is embedded in the bonded structure by, for example, placing a tablet-shaped sintered body obtained by mixing and sintering of the above-mentioned powder components on the printed electrode 2, providing thereon alumina powder or a sheet-shaped green body of alumina to cover the printed electrode 2 and the terminal 3, and causing sintering by hot press. The terminal 3 may be embedded in various other ways. For example, a tablet-shaped molded body formed by mixing the above-mentioned powder components may be placed on the printed electrode and then sintered, or a paste formed by mixing component powder may be used. However, it is preferable to use a sintered body that is sintered separately in advance as the terminal 3, in order to reduce occurrence of cracks in the bonded structure 1 and prevent diffusion of the components.

The average particle size of alumina included in the sintered NbC/alumina mixture body used as the terminal 3 is preferably 0.5 to 15 μm. When the particle size of alumina powder is large, or when the particle size of sintered alumina is grown over 15 μm due to excessive sintering of a NbC/alumina mixture, the three-dimensional bond of NbC as conductive substance gets broken to increase electrical resistivity of the terminal 3. Here, the particle size of the sintered body was measured based on observation of the cross-section of the body by the intercept method.

The connecting member 5 is preferably made of a metal having a coefficient of thermal expansion close to that of the ceramic base 4, so as to avoid lowering of the bonding strength of the connecting member 5 and the ceramic base 4 in brazing process due to difference in thermal expansion degree. Examples of such metal include niobium (Nb), molybdenum (Mo), and titanium (Ti), and titanium is most preferable of these. The coefficient of thermal expansion of Nb is 7.07×10⁻⁶/K, the coefficient of thermal expansion of Mo is 5.43×10⁻⁶/K, the coefficient of thermal expansion of Ti is 8.35×10⁻⁶/K, and the coefficient of thermal expansion of alumina is 8.0×10⁻⁶/K. Here, the coefficient of thermal expansion close to that of the ceramic base 4 represents a coefficient of thermal expansion within the difference of 33% from the coefficient of thermal expansion of the ceramic base 4.

The braze layer 6 is made of indium or indium alloy, aluminum or aluminum alloy, gold, or gold/nickel alloy. Of these, aluminum alloy is most preferable. The braze layer 6 is preferably provided in the concavity 4a to cover the terminal 3, the bottom surface of the concavity 4a, and lower wall of the concavity 4a near the bottom surface. The braze layer 6 is preferably provided not to fill the clearance 4b. If the braze layer is filled in the concavity 4a in the case where there is a difference in coefficient of thermal expansion between the ceramic base 4 and the connecting member 5, cracks may occur in the ceramic base 4 in a heating process. When the braze layer has a diameter of, for example, not less than 4 mm and not more than 6 mm, the layer 6 preferably has a thickness of more than 0.05 mm and less than 0.3 mm.

The printed electrode 2 is preferably composed of a tungsten carbide (WC)/alumina mixture. The printed electrode 2 composed of WC/alumina mixture is well bonded to the ceramic base 4 and to the terminal 3 to reduce occurrence of cracks and prevent unnecessary diffusion and reactions of the conductive substance. The printed electrode 2 may otherwise be composed of a NbC/alumina mixture.

In the bonded structure 1 with the terminal 3 embedded therein according to the embodiment, disconnection does not occur at the phase boundary between the terminal 3 and the printed electrode 2 and a fragile layer does not form at the boundary of the terminal 3 and the braze layer 6. According to the embodiment, the bonded structure 1 having a reliable property and a producing method of such a bonded structure 1 are provided.

Producing Method of Susceptor (Bonded Structure) for Semiconductor

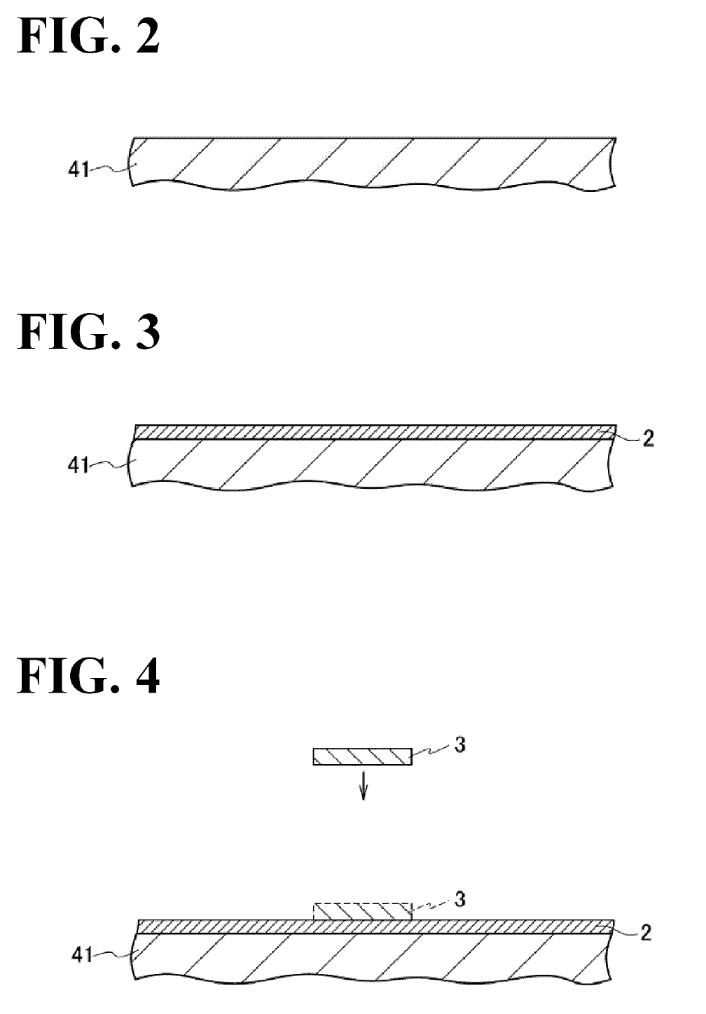

(I) As shown in FIG. 2, a first ceramic base 41 mainly composed of alumina is prepared. A surface of the first ceramic base 41, on which an electrode is formed, is ground to be flat.

(II) As shown in FIG. 3, the printed electrode 2 composed of a high-melting-point conductive carbide and alumina is formed on the surface of the first ceramic base 41. Preferably, an electrode material paste is printed on the surface of the ceramic base 41 and dried to be the printed electrode 2.

(III) Separately from the above processes, niobium carbide (NbC) powder and alumina (Al₂O₃) powder are mixed and the mixture is molded into a molded body. Preferably, NbC powder having a purity of 95% and a particle size of 0.5 μm and alumina powder having a purity of 95% and a particle size of 1 μm are mixed. Then, the molded body is sintered for 2 hours at 1800° C. under nitrogen to obtain the terminal 3 that is a sintered body having a density of not less than 95%. The obtained terminal 3 is preferably processed into a disk (tablet) shape having with a desired size.

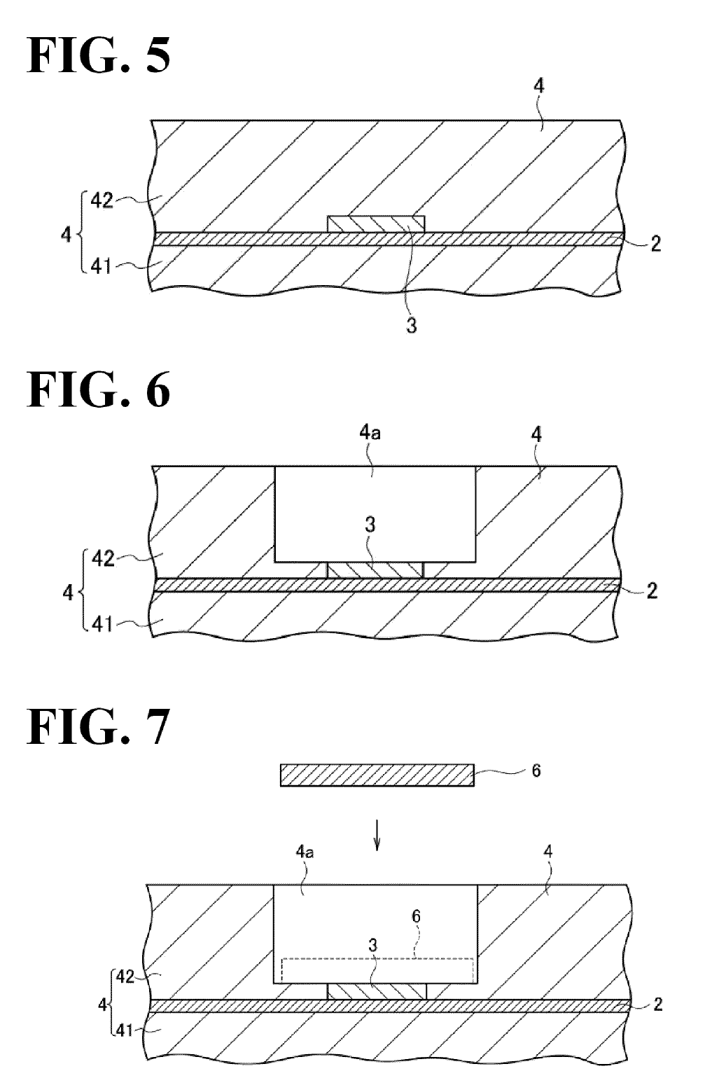

(IV) As shown in FIG. 4, the terminal 3 is placed on the printed electrode 2 so that a first surface of the terminal 3 is in contact with the electrode 2. The first ceramic base 41 with the terminal 3 thereon is placed inside a metal mold. Then, alumina powder is provided into the metal mold to cover the terminal 3 and the printed electrode 2, and pressed to obtain a molded base with the printed electrode 2 and the terminal 3 embedded therein. The molded base is sintered at 1850° C. under nitrogen by hot press. Thus, the ceramic base 4 in which the printed electrode 2 and the terminal 3 are embedded between the first ceramic base 41 and the second ceramic base 42 as shown in FIG. 5 is obtained. At this stage, the terminal 3, the printed electrode 2, and the ceramic base 4 composed of alumina surrounding the terminal 3 and the printed electrode 2 are firmly bonded to each other by sintering.

(V) Subsequently, as shown in FIG. 6, the concavity 4a is formed at the surface of the ceramic base 4 toward the printed electrode 2, so that a second surface of the terminal 3 is exposed at the bottom of the concavity 4a. The concavity 4a is preferably formed by machining. The terminal 3 may be partially ground so that the second surface of the terminal is exposed at the bottom of the concavity 4a and coplanar with the bottom surface of the concavity 4a.

(VI) As shown in FIG. 7, the braze layer 6 (brazing material) is provided in the concavity 4a to be in contact with the second surface of the terminal 3, as shown in FIG. 7.

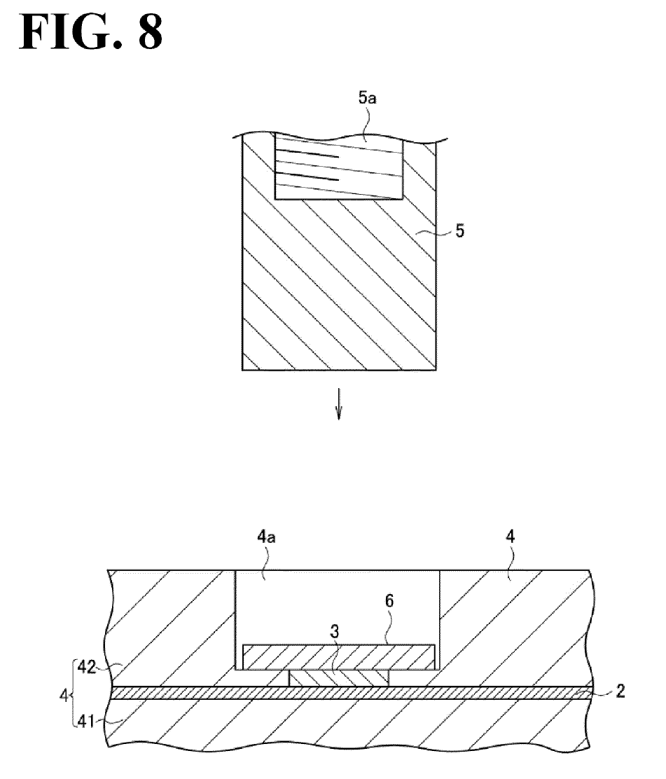

(VII) As shown in FIG. 8, the connecting member 5 made of a high-melting-point metal having a coefficient of thermal expansion close to that of the ceramic base 4 is inserted into the concavity 4a to be in contact with the braze layer 6. Then, the braze layer 6 is heated in vacuum or in inert atmosphere and melted. The heating temperature is preferably increased to 200° C. for indium as the brazing metal, 700° C. for aluminum alloy, and 1100° C. for gold. After it is confirmed that the braze layer 6 has been melted, the structure in process of production is left alone for about 5 minutes at the temperature. Then, heating is stopped and the structure is naturally cooled. At this stage, the connecting member 5 is connected to the terminal 3 via the braze layer 6. By the above-described process, the susceptor 1 as shown in FIGS. 1A to 1C is produced.

### Modified Embodiments

The above-described embodiments are only some concrete modes of carrying out the present invention and do not restrict the concept of the invention. From the above description, a person skilled in the art would conceive various alternative modes of carrying out the present invention and various applications of the present invention. As a matter of course, the present invention can be realized in various modes that are not described herein. The technical scope of the present invention shall be determined based on the statement of Claims by reference to the above-described embodiments.

### EXAMPLES

Production of Bonded Structure

Bonded structure 1 as shown in FIGS. 1A to 1C were produced in each of Examples under the conditions described below, according to the production method of the embodiment.

(I) As shown in FIG. 2, a first ceramic base 41 composed of alumina was prepared.

(II) As shown in FIG. 3, an electrode material paste composed of tungsten carbide (WC) and alumina (Al₂O₃) was printed on the surface of the first ceramic base 41 and dried, so as to form the printed electrode 2.

(III) The terminal 3 was produced based on the composition and other conditions shown in Tables 1 to 5.

(IV) As shown in FIG. 4, the terminal 3 was placed on the printed electrode 2 and the first ceramic base 41 with the terminal 3 was placed inside a metal mold. Then, alumina powder was provided into the metal mold to cover the terminal 3 and the printed electrode 2, and pressed to obtain a molded base with the printed electrode 2 and the terminal 3 embedded therein. The molded base was sintered at 1850° C. under nitrogen by hot press. Thus, a ceramic base 4 as shown in FIG. 5 was obtained.

(V) As shown in FIG. 6, a concavity 4a having a diameter of 4 mm and a depth of 4 mm was formed by machining at the surface of the ceramic base 4 to reach the terminal 3. The terminal 3 was partially ground so that the second surface was exposed at the bottom of the concavity 4a and coplanar with the bottom surface of the concavity 4a.

(VI) As shown in FIG. 7, a braze layer 6 composed of aluminum-1% of silicon alloy was provided in the concavity 4a to be in contact with the second surface of the terminal 3, as shown in FIG. 7.

(VII) As shown in FIG. 8, a connecting member 5 made of titanium was inserted into the concavity 4a to be in contact with the braze layer 6. Then, the braze layer 6 was heated for 5 minutes at 700° C.

By the above process, the connecting member 5 was connected to the ceramic base 4 via the braze layer 6. The bonded structure 1 including the terminal 3 and the braze layer on the terminal 3 as shown in FIGS. 1A to 1C was produced in each of Examples.

The bonded structures of Examples 1 to 15 and Comparative Examples 1 to 8 produced as above were subject to the following evaluation tests.

[Evaluation Test]

1. Coefficient of Thermal Expansion CTE (unit: ×10⁻⁶/° C.)

The coefficient of thermal expansion of the sintered body having each composition condition as the terminal 3 of each Example was measured according to JIS R1618.

2. Electrical Volume Resistivity ρ (unit: Ωcm)

The sintered body as the terminal 3 of each Example was cut into a rectangular column in a size of 4 mm×5 mm×25 mm. Electrodes were formed using silver paste at the position of 2 mm and 4 mm from the both ends, and electrical volume resistivity was measured according to a four-terminal method (in compliance with JIS K7194, Testing Method for Resistivity of Conductive Plastics with a Four-Point Probe Array).

3. Terminal Resistance R (unit: Ωcm)

The resistance of the disc-shaped sintered tablet was measured by making testers in contact with the centers of upper and bottom faces of the tablet.

4. Occurrence of Cracks

Occurrence of cracks was checked by a fluorescent-penetrant inspection method. Specifically, each sample was immersed in ZYGLO solution (Magnaflux Corporation), and, after the ZYGLO solution on the sample was wiped off, the sample was irradiated with ultraviolet light for checking existence of cracks. Here, 10 samples were prepared with respect to each of the production conditions, and the number of samples having a crack was counted.

5. Occurrence of Cracks by Heat Cycle

An external heater was used to heat the entire susceptor from the room temperature to 100° C. at the rate of increasing 5° C./sec, and then the susceptor was cooled down naturally to the room temperature. A series of this process was repeated 1,000 times, and existence of cracks was checked in the same manner as in the fluorescence flaw detection.

6. Diffusion

Occurrence of diffusion of W or Nb was checked by observing a cross section of each sample with an SEM and studying distribution of W element or Nb element in the cross section.

### Examples 1 and 2, and Comparative Examples 1 and 2

Evaluation was conducted with respect to Examples 1 and 2, and Comparative Examples 1 and 2, in order to study the effect of material of the terminal 3. Table 1 shows the production conditions and evaluation results of the examples.

TABLE 1

| | Details of Terminal | | | | | | | | | |
|---|---|---|---|---|---|---|---|---|---|---|
| | | | Sintered | | Results of Evaluation | | | | | |
| | | | Al₂O₃ | | | | | Number of | | |
| | | Al₂O₃ | Average | | | | | Samples | | |
| | | Content | Particle | | | | | with Crack | Heat | |
| | | Rate | Size | Shape | CTE | ρ | R | (per 10 | Cyle | Overall |
| | Material | (wt %) | (μm) | (mm) | (10⁻⁶/K) | (Ωcm) | (Ω) | Samples) | Property | Evaluation |
| Example 1 | NbC | 5 | 0.5 | φ3 × 0.5t | 7.3 | 8.0E−05 | 5.6E−04 | 0 | Good | Good |
| Example 2 | NbC | 50 | 0.5 | φ3 × 0.5t | 7.7 | 5.6E−04 | 3.9E−03 | 0 | Good | Good |
| Comparative | WC | 5 | 0.5 | φ3 × 0.5t | 5.3 | 2.0E−04 | 1.4E−03 | 10 | — | Poor |
| Example 1 | | | | | | | | | | |
| Comparative | WC | 50 | 0.5 | φ3 × 0.5t | 7.1 | 1.4E−03 | 9.8E−03 | 3 | Poor | Poor |
| Example 2 | | | | | | | | | | |

As can be seen from Table 1, while cracks occurred in the terminal 3 mainly composed of tungsten carbide (WC), cracks did not occur in the terminal 3 mainly composed of niobium carbide (NbC). In addition, it was found that the terminal 3 mainly composed of niobium carbide (NbC) exhibited good heat cycle property. It was concluded that it was more preferable to use niobium carbide (NbC) than tungsten carbide (WC) as the main component of the terminal 3. It is thought that, by using niobium carbide, the coefficient of thermal expansion closer to alumina can be attained, and that stress applied during the production process and during usage is decreased to reduce occurrence of cracks. When the content rate of alumina is fixed, the terminal 3 mainly composed of niobium carbide still has a lounger electrical volume resistivity than the terminal 3 mainly composed of tungsten carbide, and is suitable as a conductive member.

### Examples 3 to 7, and Comparative Examples 3 and 4

Evaluation was conducted with respect to Examples 3 to 7, and Comparative Examples 3 and 4, in order to define preferable amount of alumina included in the terminal 3. Table 2 shows the production conditions and evaluation results of the examples.

TABLE 2

| | Details of Terminal | | | | | | | | | |
|---|---|---|---|---|---|---|---|---|---|---|
| | | | Sintered | | | Results of Evaluation | | | | |
| | | | Al₂O₃ | | | | | | Number of | |
| | | Al₂O₃ | Average | | | | | | Samples | |
| | | Content | Particle | | | | | | with Crack | |
| | | Rate | Size | Shape | Embedding | CTE | ρ | R | (per 10 | |
| | Material | (wt %) | (μm) | (mm) | Method | (10⁻⁶/K) | (Ωcm) | (Ω) | Samples) | Diffusion |
| Comparative | NbC | 0 | 0.5 | φ3 × 0.5t | Sintered | 7.2 | 1.5E−05 | 1.1E−04 | 3 | NO |
| Example 3 | | | | | Body | | | | | |
| Example 3 | NbC | 5 | 0.5 | φ3 × 0.5t | Sintered | 7.3 | 8.0E−05 | 5.6E−04 | 0 | NO |
| | | | | | Body | | | | | |
| Example 4 | NbC | 20 | 0.5 | φ3 × 0.5t | Sintered | 7.5 | 2.0E−04 | 1.4E−03 | 0 | NO |
| | | | | | Body | | | | | |
| Example 5 | NbC | 40 | 0.5 | φ3 × 0.5t | Sintered | 7.6 | 2.5E−04 | 1.7E−03 | 0 | NO |
| | | | | | Body | | | | | |
| Example 6 | NbC | 50 | 0.5 | φ3 × 0.5t | Sintered | 7.7 | 5.6E−04 | 3.9E−03 | 0 | NO |
| | | | | | Body | | | | | |
| Example 7 | NbC | 60 | 0.5 | φ3 × 0.5t | Sintered | 7.75 | 9.0E−04 | 6.3E−03 | 0 | NO |
| | | | | | Body | | | | | |
| Comparative | NbC | 70 | 0.5 | φ3 × 0.5t | Sintered | 7.8 | 2.0E−02 | 1.4E−01 | 0 | NO |
| Example 4 | | | | | Body | | | | | |

As can be seen from Table 2, when the content rate of alumina was not less than 5 wt %, occurrence of cracks was prevented. And, when the content rate of alumina was not more than 60 wt %, low electrical resistivity of the terminal 3 was attained. The low electrical resistivity contributes to inhibition of generation of Joule heat, thus preventing occurrence of a hot spot in the ceramic base 4 in a part corresponding to the terminal 3. It is thought that the three-dimensional bond of NbC as conductive substance gets broken to drastically increase the electrical resistivity of the terminal 3, when the content rate of alumina is more than 60 wt %.

### Examples 8 to 11, and Comparative Example 5

Evaluation was conducted with respect to Examples 8 to 11, and Comparative Example 5, in order to study the effect of the average particle size of alumina after sintering. Table 3 shows the production conditions and evaluation results of the examples.

TABLE 3

| | Details of Terminal | | | | | | | | | |
|---|---|---|---|---|---|---|---|---|---|---|
| | | | Sintered | | | Results of Evaluation | | | | |
| | | | Al₂O₃ | | | | | | Number of | |
| | | Al₂O₃ | Average | | | | | | Samples | |
| | | Content | Particle | | | | | | with Crack | |
| | | Rate | Size | Shape | Embedding | CTE | ρ | R | (per 10 | |
| | Material | (wt %) | (μm) | (mm) | Method | (10⁻⁶/K) | (Ωcm) | (Ω) | Samples) | Diffusion |
| Example 8 | NbC | 50 | 0.5 | φ1 × 0.5t | Sintered | 7.7 | 5.6E−04 | 3.5E−02 | 0 | NO |
| | | | | | Body | | | | | |
| Example 9 | NbC | 50 | 9 | φ1 × 0.5t | Sintered | 7.7 | 5.2E−04 | 3.3E−02 | 0 | NO |
| | | | | | Body | | | | | |
| Example 10 | NbC | 50 | 15 | φ1 × 0.5t | Sintered | 7.7 | 5.5E−04 | 3.5E−02 | 0 | NO |
| | | | | | Body | | | | | |
| Example 11 | NbC | 50 | 31 | φ1 × 0.5t | Sintered | 7.7 | 8.9E−04 | 5.6E−02 | 0 | NO |
| | | | | | Body | | | | | |
| Comparative | NbC | 50 | 48 | φ1 × 0.5t | Sintered | 7.7 | 4.0E−02 | 2.5E−00 | 0 | NO |
| Example 5 | | | | | Body | | | | | |

As can be seen from Table 3, when the average particle size of alumina included in the sintered tablet as the terminal 3 was not more than 31 μm, low electrical volume resistivity of the terminal 3 was attained. It can be said that the average particle size of alumina is preferably within the range of 0.5 to 15 μm. It is thought that, when sintering progresses and the average particle size of alumina exceeds 31 μm, network of NbC particles tends to be broken to drastically increase the electrical volume resistivity.

### Examples 12 to 14, and Comparative Example 6

Evaluation was conducted with respect to Examples 12 to 14, and Comparative Example 6, in order to study the effect of the shape of the terminal 3. Table 4 shows the production conditions and evaluation results of the examples.

TABLE 4

| | Details of Termina; | | | | | | | | |
|---|---|---|---|---|---|---|---|---|---|
| | | | Sintered | | | Results of Evaluation | | | |
| | | | Al₂O₃ | | | | | Number of | |
| | | Al₂O₃ | Average | | | | | Samples | |
| | | Content | Particle | | | | | with Crack | |
| | | Rate | Size | Shape | Embedding | CTE | ρ | (per 10 | |
| | Material | (wt %) | (μm) | (mm) | Method | (10⁻⁶/K) | (Ωcm) | Samples) | Diffusion |
| Example 12 | NbC | 50 | 0.5 | φ1 × 0.5t | Sintered | 7.7 | 5.6E−04 | 0 | NO |
| | | | | | Body | | | | |
| Example 13 | NbC | 50 | 0.5 | φ2 × 0.5t | Sintered | 7.7 | 5.6E−04 | 0 | NO |
| | | | | | Body | | | | |
| Example 14 | NbC | 50 | 0.5 | φ3 × 0.5t | Sintered | 7.7 | 5.6E−04 | 0 | NO |
| | | | | | Body | | | | |
| Comparative Example 6 | NbC | 50 | 0.5 | φ4 × 0.5t | Sintered | 7.7 | 5.6E−04 | 2 | NO |
| | | | | | Body | | | | |

As can be seen from Table 4, no crack was occurred in the terminal having a diameter of 3 mm according to Example 14. It is found possible to use a bigger terminal to allow a lager current flow than the conventional terminal, when the terminal is made of a sintered body of a NbC/alumina mixture. Still, the diameter of the terminal is preferably not more than 3 mm.

### Example 15, and Comparative Examples 7 and 8

Evaluation was conducted with respect to Example 15, and Comparative Examples 7 and 8, in order to study the effect of the embedding method the terminal 3. Table 5 shows the production conditions and evaluation results of the examples.

TABLE 5

| | Details of Terminal | | | | | | |
|---|---|---|---|---|---|---|---|
| | | | Sintered | | | Results of Evaluation | |
| | | | Al₂O₃ | | | Number of | |
| | | Al₂O₃ | Average | | | Samples | |
| | | Content | Particle | | | with Crack | |
| | | Rate | Size | Shape | Embedding | (per 10 | |
| | Material | (wt %) | (μm) | (mm) | Method | Samples) | Diffusion |
| Example 15 | NbC | 50 | 0.5 | φ1 × 0.5t | Sintered Body | 0 | NO |
| Comparative Example 7 | NbC | 50 | 0.5 | φ1 × 0.5t | Press Processing | 9 | YES |
| | | | | | of Powder | | |
| Comparative Example 8 | NbC | 50 | 0.5 | φ1 × 0.5t | Solidification | 9 | YES |
| | | | | | of Paste | | |

As can be seen from Table 5, occurrence of cracks was prevented when a sintered body that had been sintered in advance was embedded in the ceramic base. When powder was press processed to be the terminal 3 or when a paste was solidified to be the terminal 3, diffusion of Nb elements in the neighboring alumina ceramic was observed in observation using the SEM. This diffusion is thought to have caused cracks during the producing process of the bonded structure.

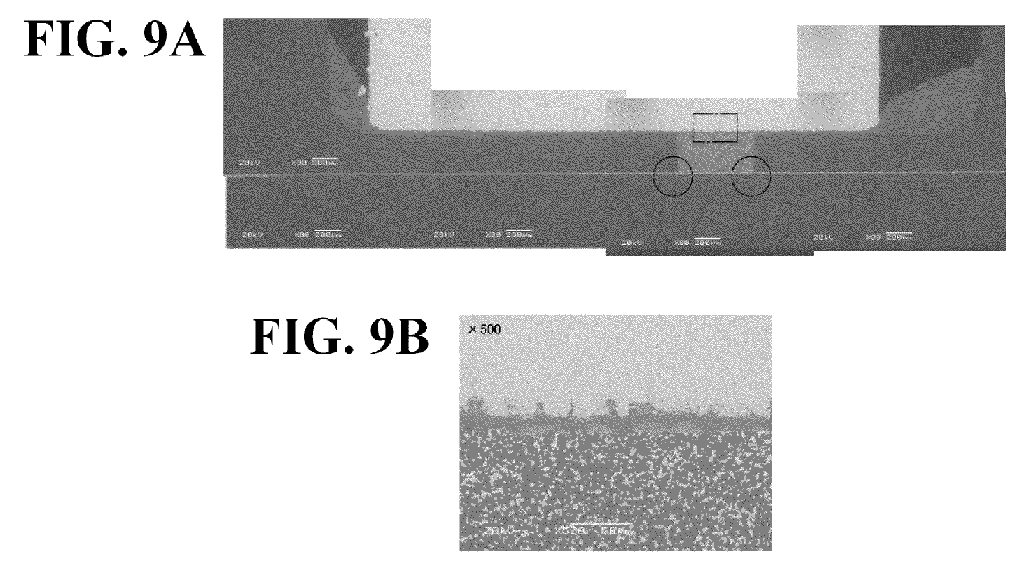

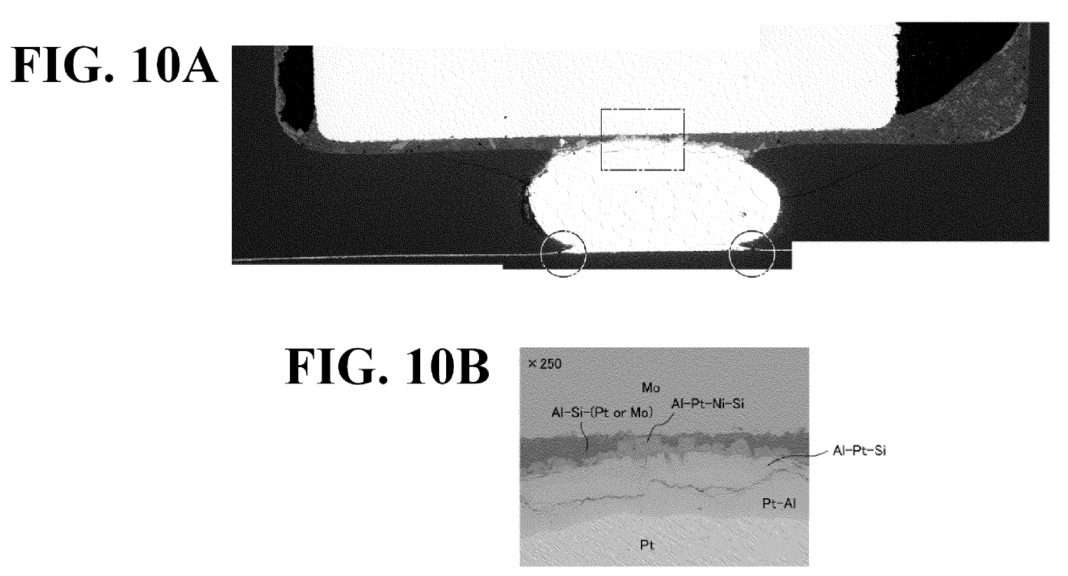

The susceptor according to Example 9 was cut in the longitudinal direction and thus obtained cross section was observed to study conditions of the phase boundary between the terminal 3 and the printed electrode 2 and the phase boundary between the terminal 3 and the braze layer 6. FIG. 9A is a SEM photo of the cross section of the bonded structure according to Example 9. In FIG. 9A, circle areas defined by dashed-dotted lines include the phase boundary between the terminal and the printed electrode 2, and a square area defined by a dashed-dotted line includes the phase boundary between the terminal and the braze layer 6. FIG. 9B shows an enlarged view of a part of the square area in FIG. 9A. A comparative example was produced as a conventional susceptor (bonded structure) including a terminal composed of platinum (Pt) and a connecting member composed of Mo. FIG. 10A and 10B are a SEM photo and an enlarged partial view of a cross section of thus produced comparative example.

As can be seen from FIG. 9A, in the bonded structure according to Example 9, the terminal 3 and the printed electrode 2 are bonded tightly at the boundaries, and, neither reaction of the terminal 3 with the printed electrode 2 nor deformation of the terminal 3 or the printed electrode 2 was observed. Therefore, a good conductive property is achieved. In addition, as can be seen from FIG. 9B, no fragile layer was observed in the phase boundary between the terminal 3 and the braze layer 6. Therefore, a high brazing reliability is achieved and the bonded structure 1 is not easily damaged even when a load is applied to the braze layer 6. In the conventional bonded structure, on the other hand, disconnections were observed near the phase boundary of the terminal 3 and the printed electrode 2, as can be seen from FIG. 10A. It is thought that the disconnections were caused by reactions of platinum with WC in the sintering process of the ceramic at a high temperature. Besides, a fragile layer was observed in the conventional bonded structure, as can be seen from FIG. 10B. In the brazing process at a high temperature, platinum, Al, and Mo were reacted with each other to produce intermetallic compounds thereof, and these intermetallic compounds formed the fragile layer. In the measurement of the breaking strength of the connecting member, it was found that the breaking strength of the connecting member 5 of Example 13 was 2.2 times that of the conventional bonded structure. From the above evaluations, it is clearly shown that the bonded structure 1 in which the terminal 3 is reliably bonded to the printed electrode 2 and with the braze layer is obtained according to the present invention.

The present application claims priority from the Japanese Patent Application No. 2008-172746 filed on Jul. 1, 2008, the entire contents of which are incorporated herein by reference.

What is claimed is:

1. A bonded structure, comprising:
a ceramic base that is mainly composed of alumina, includes a printed electrode embedded therein and composed of a high-melting-point conductive carbide and alumina, and has a concavity and a terminal hole, the concavity being concaved at a surface of the ceramic base toward the printed electrode and the terminal hole extending from a bottom of the concavity to the printed electrode;
a terminal that is made of a sintered body of a mixture of niobium carbide (NbC) and alumina (Al₂O₃) and is placed in the terminal hole so that a first surface of the terminal is in contact with the printed electrode and a second surface of the terminal is exposed at the bottom of the concavity;
a braze layer that is provided in the concavity to be in contact with the second surface of the terminal; and
a connecting member that is made of a high-melting-point metal having a coefficient of thermal expansion close to that of the ceramic base and is inserted into the concavity to be in contact with the braze layer.

2. The bonded structure according to claim 1, wherein the terminal is composed only of niobium carbide and alumina, and contains not less than 5 wt % and not more than 60 wt % of alumina with respect to the total weight of the terminal.

3. The bonded structure according to claim 1, wherein the connecting member is preferably made of a material selected from the group consisting of niobium, molybdenum, and titanium.

4. The bonded structure according to claim 1, wherein the terminal has a diameter of not more than 3 mm.

5. An electrostatic chuck including the bonded structure according to claim 1, wherein the ceramic base of the bonded structure has a purity of Al₂O₃ of not less than 99.5% and a volume resistivity of not less than 1'10¹⁵ Ωcm.

6. A method of producing a bonded structure, comprising:
forming a printed electrode composed of a high-melting-point conductive carbide and alumina on a surface of a first ceramic base composed mainly of alumina;
placing a terminal made of a sintered body of a mixture of niobium carbide (NbC) and alumina (Al₂O₃) so that a first surface of the terminal is in contact with the printed electrode;
providing alumina powder to cover the terminal and the printed electrode and firing the alumina powder to form a second ceramic base, so as to obtain an integral ceramic base in which the printed electrode and the terminal are embedded between the first ceramic base and the second ceramic base;
forming a concavity that is concaved at a surface of the integral ceramic base toward the printed electrode to expose a second surface of the terminal at a bottom of the concavity;
providing a braze layer in the concavity to be in contact with the second surface of the terminal; and
inserting a connecting member made of a high-melting-point metal having a coefficient of thermal expansion close to that of the integral ceramic base into the concavity to be in contact with the braze layer.

7. The method according to claim 6, wherein the terminal is composed only of niobium carbide and alumina, and contains not less than 5 wt % and not more than 60 wt % of alumina with respect to the total weight of the terminal.

8. The method according to claim 6, wherein the connecting member is preferably made of a material selected from the group consisting of niobium, molybdenum, and titanium.

9. The method according to claim 6, wherein the terminal has a diameter of not more than 3 mm.

10. The method according to claim 6, wherein the alumina included in the terminal has an average particle size of not more than 31 μm.
